(19) United States
(12) Patent Application Publication
(10) Pub. No.: US 2020/0232938 A1
(43) Pub. Date: Jul. 23, 2020

(54) MODULAR PHANTOM AND METHOD FOR IMAGE QUALITY ASSESSMENT USING INTERCHANGEABLE INSERTS

(71) Applicant: General Electric Company, Schenectady, NY (US)

(72) Inventors: Paul Francis Fitzgerald, Schenectady, NY (US); John Scott Price, Niskayuna, NY (US); William Robert Ross, Kinderhook, NY (US); Mingye Wu, Clifton Park, NY (US); Lin Fu, Niskayuna, NY (US); Michelle Brault, Ballston Spa, NY (US); Bruno Kristiaan Bernard De Man, Clifton Park, NY (US); Xin Li, Niskayuna, NY (US)

(21) Appl. No.: 16/745,836

(22) Filed: Jan. 17, 2020

Related U.S. Application Data
(60) Provisional application No. 62/794,398, filed on Jan. 18, 2019.

(51) Int. Cl. G01N 23/046; G06T 7/00; G06T 11/00

(52) U.S. Cl. CPC G01N 23/046; G06T 7/0004; G06T 11/003; G06T 2207/30168; G06T 2207/10081; G01N 2223/3035; G06T 2207/30108

(57) ABSTRACT

The present disclosure relates to the design of phantoms configurable using one or more inserts and to their use in generating images that may be used to compare image quality between different imaging systems. Such phantoms may have a modular design with inserts that may be exchanged one for another within a phantom body.

### CROSS-REFERENCE TO RELATED APPLICATION

This application claims priority to and the benefit of U.S. Provisional Application No. 62/794,398, entitled “MODULAR PHANTOM AND METHOD FOR IMAGE QUALITY ASSESSMENT USING INTERCHANGABLE INSERTS”, filed Jan. 18, 2019, which is herein incorporated by reference in its entirety.

### STATEMENT REGARDING FEDERALLY SPONSORED RESEARCH & DEVELOPMENT

This invention was made with Government support under contract number FA8604-16-C-7008 awarded by U.S. Airforce Research Lab (AFRL). The Government has certain rights in the invention.

### TECHNICAL FIELD

The present disclosure relates to a phantom capable of being configured and re-configured using inserts and used with X-ray-based imaging systems, such as for image quality assessment in certain embodiments.

### BACKGROUND

Computed tomography (CT) and other X-ray-based imaging systems may be used to assess manufactured goods for defects or perform other quality control type tasks without damaging or destroying the item being examined. Such tasks may be characterized in the industry as non-destructive testing (NDT) or non-destructive evaluation (NDE). By way of example, such a CT-based NDT system may emit a fan- or cone-shaped X-ray beam toward an object being evaluated or assessed and may reconstruct a two-dimensional (2D) or three-dimensional (3D) image or model using the detected X-rays that pass through the object. These detected X-rays convey information about the extent to which the X-rays are attenuated by their passage through different regions or portions of the object and such information may be acquired at a number of angular views about the object, allowing a volumetric interior representation of the object to be reconstructed.

While CT imaging techniques can be useful in performing such non-destructive testing, these techniques may be subject to certain effects that can be detrimental to the reconstructed images. For example, X-rays may be scattered from their path by material in the beam path, an effect known as scatter, and these scattered X-rays, when detected, can degrade image quality (IQ) of the reconstructed image. These scatter effects may be so extensive as to impair the processes that rely on the reconstructed images. Similarly, the image spatial resolution is impacted by many blurring effects depending on the X-ray focal spot size, detector pitch and reconstruction algorithm. Degraded IQ due to, for example, these scatter and blurring effects, can negatively impact assessment of the quality of manufactured parts with respect to geometric accuracy (i.e., metrology) and/or defects (e.g., pores).

With this in mind, scatter and blurring, along with other factors, can degrade or otherwise impact the image quality of CT based imaging systems. However, it may be difficult to compare different CT systems, or similar systems with different settings, with respect to image quality due to the myriad factors and tradeoffs that contribute to image quality. This may be further complicated by the lack of standardization in such NDT systems. With this in mind, it may be desirable to be able to compare the image quality of image acquired on different on different CT scanners for a variety of purposes.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible embodiments. Indeed, the invention may encompass a variety of forms that may be similar to or different from the embodiments set forth below.

The present techniques relate to the design of phantoms configurable using one or more inserts and to their use in generating images that may be used to compare image quality between different imaging systems. Such phantoms may have a modular design with inserts that may be exchanged one for another within a phantom body. The use of such modular phantom bodies with inserts provides the ability to use micro-CT or other means to determine ground truth for the insert's small feature sizes. Then the ground truth result can be compared with the result when the insert is installed in the phantom body and scanned with the scanner to be characterized, herein called “macro-CT”. Inserts can include samples of real manufactured material, such as porous additively-manufactured material, but also potentially real material with other defects such as sample with a known crack, etc.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram representation of a computed tomography (CT) system suitable for use in non-destructive testing (NDT), in accordance with aspects of the present disclosure;

FIG. 2 depicts a modular, nesting phantom design, in accordance with aspects of the present disclosure;

FIG. 3 depicts an image of an annular phantom and cover, in accordance with aspects of the present disclosure;

FIG. 4 depicts an example of a part-specific modular phantom and cover, here corresponding to an airfoil, in accordance with aspects of the present disclosure;

FIG. 5 depicts the phantom body and cover of the part-specific modular phantom of FIG. 4 combined, in accordance with aspects of the present disclosure;

FIG. 6 depicts a modular, annular phantom in combination with scatter-producing extensions, in accordance with aspects of the present disclosure;

FIG. 7 depicts a modular, part-specific phantom in combination with scatter-producing extensions, in accordance with aspects of the present disclosure;

FIG. 8 depicts gusset inserts, in accordance with aspects of the present disclosure;

FIG. 9 depicts semicircle inserts, in accordance with aspects of the present disclosure;

FIG. 10 depicts a circular insert with pores formed in an end of the insert, in accordance with aspects of the present disclosure;

FIG. 11 depicts semicircle inserts with pores formed in a flat surface, in accordance with aspects of the present disclosure; and

FIGS. 12A, 12B, 12C, and 12D collectively depict 2D and 3D renderings of micro-CT images of a “bucket of balls” insert, in accordance with aspects of the present disclosure.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While aspects of the following discussion may be provided in the context of industrial or commercial imaging, such as for non-destructive testing (NDT) of manufactured parts, it should be appreciated that the present techniques are not limited to such industrial contexts. Indeed, the provision of examples and explanations in such a manufacturing context is only to facilitate explanation by providing instances of real-world implementations and applications. However, the present approaches may also be utilized in other contexts, such as non-invasive inspection of packages, boxes, luggage, and so forth (i.e., security or screening applications). In general, the present approaches may be useful in any imaging or screening context or image processing field where image quality and/or scatter and/or blurring effects are a consideration.

The present technique relates to the design of phantoms configurable using one or more inserts and to their use in generating images that may be used to compare image quality between different imaging systems. Such phantoms may have a modular design with inserts that may be exchanged one for another within a phantom body. The use of such modular phantom bodies with inserts provides the ability to use micro-CT or other means to determine ground truth for the insert's small feature sizes. Then the ground truth result can be compared with the result when the insert is installed in the phantom body and scanned with the scanner to be characterized, herein called “macro-CT”. Inserts can include samples of real manufactured material, such as porous additively-manufactured material, but also potentially real material with other defects such as sample with a known crack, etc.

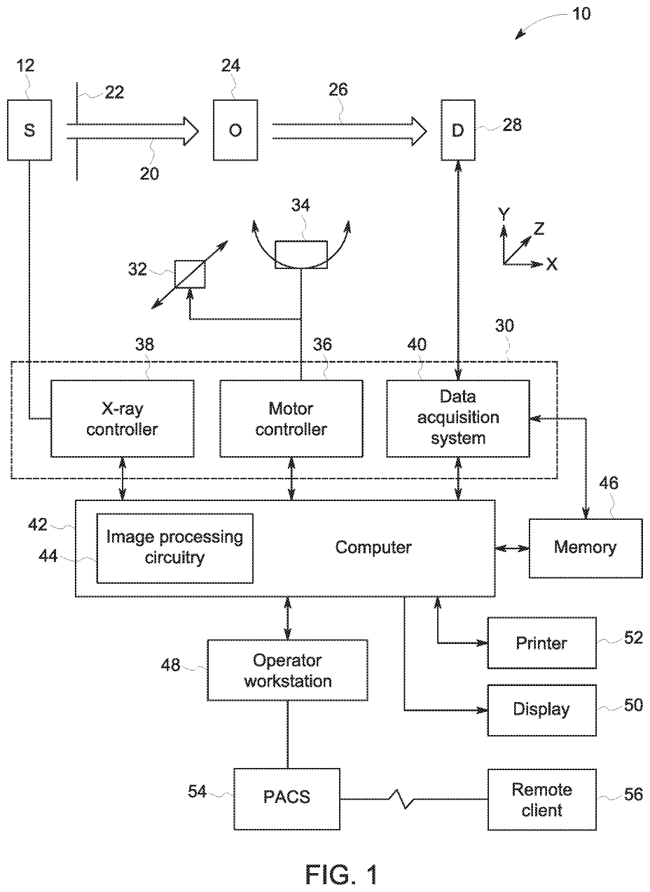

With the preceding discussion in mind, FIG. 1 illustrates an embodiment of an imaging system 10 for acquiring and processing image data, such as non-destructive testing data, in accordance with structures and approaches discussed herein. In the illustrated embodiment, system 10 is a CT system designed to acquire X-ray projection data and to reconstruct the projection data into volumetric reconstructions for display and analysis. The CT imaging system 10 includes one or more X-ray sources 12, such as one or more X-ray tubes or solid-state emission structures which allow X-ray generation at one or more locations and/or one or more energy spectra during an imaging session. In the context of industrial CT, as discussed by way of example herein, the imaging spectrum provided by an X-ray source 12 ranged from approximately 250 kVp to 10 MVp.

In certain implementations, the X-ray source 12 may be positioned proximate to a collimator/filter assembly 22 that may be used to spatially vary or constrain the X-ray beam 20, to define the shape (such as by limiting off-angle emissions) and/or extent of a high-intensity region of the X-ray beam 20, to control or define the energy spectrum of the X-ray beam 20, and/or to otherwise limit X-ray exposure on those portions of the object 24 not within a region of interest.

The X-ray beam 20 passes into a region in which the object 24 (e.g., manufactured component, baggage, package, and so forth) is positioned. The subject attenuates at least a portion of the X-ray photons 20, resulting in attenuated X-ray photons 26 that impinge upon a detector array 28, which in some implementations is formed of a plurality of detector elements (e.g., pixels) arranged in an m×n array. The detector 28 may directly or indirectly (such as via a scintillator material) convert impinging X-rays to electrical signals. The electrical signals are acquired and processed to generate one or more projection datasets. In the depicted example, the detector 28 is coupled to the system controller 30, which commands acquisition of the digital signals generated by the detector 28.

A system controller 30 commands operation of the imaging system 10 to execute X-ray production, collimation/filtration, examination and/or calibration protocols, and may process the acquired data. With respect to the X-ray source 12, the system controller 30 furnishes power, focal spot location, control signals and so forth, for the NDT scan sequences. In accordance with certain embodiments, the system controller 30 may control operation of the collimator/filter assembly 22, the CT gantry (or other structural support to which the X-ray source 12 and detector 28 are attached), and/or the translation, rotation, and/or inclination of a support or table on which the object 24 being imaged is positioned over the course of an examination.

In addition, the system controller 30, via a motor controller 36, may control operation of a linear positioning subsystem 32 and/or a rotational subsystem 34 used to move the object 24 and/or components of the imaging system 10, respectively. For example, in an NDT CT system, the radiation source 12 and detector 28 may be rotated about the object 24 or, alternatively, the object 24 may be rotated on a table or support with the source 12 and detector 28 remaining stationary. In either scenario, X-ray transmission data may be acquired over a range of angular positions or views. Thus, in a real-world implementation, the imaging system 10 is configured to generate X-ray transmission data corresponding to each of a plurality of angular positions (e.g., 360°, 180°+a fan beam angle (α), and so forth) covering an entire scanning area of interest.

The system controller 30 may include signal processing circuitry and associated memory circuitry. In such embodiments, the memory circuitry may store programs, routines, and/or encoded algorithms executed by the system controller 30 to operate the imaging system 10, including the X-ray source 12 and/or collimator/filter assembly 22, and to process the digital measurements acquired by the detector 28 in accordance with the steps and processes discussed herein. In one embodiment, the system controller 30 may be implemented as all or part of a processor-based system.

The source 12 may be controlled by an X-ray controller 38 contained within the system controller 30. The X-ray controller 38 may be configured to provide power, timing signals, and/or focal spot size and spot locations to the source 12. In addition, in some embodiments the X-ray controller 38 may be configured to selectively activate the source 12 such that tubes or emitters at different locations within the system 10 may be operated in synchrony with one another or independent of one another or to switch the source 12 between different energy spectra (e.g., high- and low-energy spectra) during an imaging session.

The system controller 30 may include a data acquisition system (DAS) 40. The DAS 40 receives data collected by readout electronics of the detector 28, such as digital signals from the detector 28. The DAS 40 may then convert and/or pre-process the data for subsequent processing by a processor-based system, such as a computer 42. In certain implementations discussed herein, circuitry within the detector 28 may convert analog signals of the detector to digital signals prior to transmission to the data acquisition system 40. The computer 42 may include or communicate with one or more non-transitory memory devices 46 that can store data processed by the computer 42, data to be processed by the computer 42, or instructions to be executed by image processing circuitry 44 of the computer 42. For example, a processor of the computer 42 may execute one or more sets of instructions stored on the memory 46, which may be a memory of the computer 42, a memory of the processor, firmware, or a similar instantiation. By way of example, the image processing circuitry 44 of the computer 42 may be configured to generate an NDT diagnostic image or images. In one embodiment, the NDT image(s) are generated using image reconstruction techniques applied to the plurality of signals obtained from the plurality of pixels comprising detector 28. In one embodiment, the NDT image is displayed on a display device 50 for assisting a technician or other part or process evaluator.

The computer 42 may also be adapted to control features enabled by the system controller 30 (i.e., scanning operations and data acquisition), such as in response to commands and scanning parameters provided by an operator via an operator workstation 48. The system 10 may also include a display 50 coupled to the operator workstation 48 that allows the operator to view relevant system data, imaging parameters, raw imaging data, reconstructed image data, and so forth. Additionally, the system 10 may include a printer 52 coupled to the operator workstation 48 and configured to print any desired measurement results. The display 50 and the printer 52 may also be connected to the computer 42 directly (as shown in FIG. 1) or via the operator workstation 48. Further, the operator workstation 48 may include or be coupled to a picture archiving and communications system (PACS) 54. PACS 54 may be coupled to a remote system or client 56 so that others at different locations can gain access to the image data.

With the preceding discussion of an overall imaging system 10 in mind, various considerations relevant to NDT CT systems may be discussed in greater detail. For example, one consideration with respect to CT is that fan-beam CT (FBCT) produces high image quality (IQ) due to minimal X-ray scatter (due to X-ray transmission being limited in the z-dimension of the image volume), but suffers from excessively long scan times (due to the same z-dimension limitation). Conversely, cone-beam CT (CBCT) requires substantially shorter scan time due to the greater z-dimension exposure, but suffers from degraded IQ due to high scatter. While various approaches may be taken to address the respective tradeoffs between these two approaches, evaluating such approaches typically involves comparing the IQ of images acquired using different scanners that might vary in multiple ways, for example, be based on different architectures and/or use different scan parameters and protocols, and/or comparing the image quality (IQ) of images acquired on one scanner that might be operated in multiple ways, for example, be configurable for FBCT or CBCT and/ or use different scan parameters and protocols.

As may be appreciated, there are a myriad of factors that contribute to IQ, with scatter being just one such factor, though a highly relevant factor for cone-beam CT. However, to make valid IQ comparisons between images coming from various CT systems, all important factors should be accounted for. The primary factors that contribute to CT IQ include: a) spatial resolution, which depends on system geometry, source and detector characteristics, and recon algorithm; and b) noise (in a broad sense), which includes random noise and artifacts, both of which depend on fundamental X-ray physics such as quantum noise, spectral effects like “beam hardening”, and scatter. Together, spatial resolution and noise determine IQ, which in turn determines the ability of CT to provide required information such as part geometry (metrology, which may relate to surface location and/or wall thickness measurement tasks in an NDT context) and to characterize defects that are often manifested as small features (e.g., pores or cracks in an NDT context) on the order of a few mils to tens of mils in size.

Further, NDT CT may differ from other CT approaches in that the medium being imaged may necessitate a high energy spectrum (e.g., >150 kilovolts peak (kVp)) be generated by the source 12 in order to penetrate a large manufactured object and/or high-density alloys from which such objects may be constructed. With this in mind, X-ray generation by a source 12 used in NDT contexts may span a wide array of techniques. For example, spectra up to approximately 450 kVp can be achieved with “Coolidge”-type X-ray tubes that typically employ tungsten anodes. Such tubes can use focal spot (FS) sizes of several mm down to 1 mm or smaller and the resulting spatial resolution of the CT system can therefore be on the order of approximately 1 mm down to a few hundred microns (10 s of mils) or less. Focal spot sizes can be much smaller than 1 mm for micro-CT, sometimes yielding system spatial resolution of less than 10 microns, but micro-CT usually uses “Coolidge”-type X-ray tubes and therefore is limited to approximately 450 kVp, and, when using a small focal spot size, electron-beam current is limited to approximately 1 mA or less. Therefore, to achieve high spatial resolution in reasonable scan times, micro-CT can only scan parts made of highly-attenuation material such as metal with relatively short path lengths, for example, approximately ½ inch of steel. In comparison, high-energy X-ray sources, typically 1 to 9 megavolts (MeV), are implemented using a linear accelerator (linac). This technology typically results in a FS size of 1 to several mm and therefore the system spatial resolution can be from several hundred microns up to approximately 1 mm. Linac-based NDT scanners can produce much higher X-ray flux than micro-CT scanners and because of this, combined with the higher-energy spectra, these can scan larger parts with, for example, path lengths of several inches of steel or high-temperature superalloys, which often include tungsten. Furthermore, in some linac-based NDT applications, there is sufficient X-ray flux that the X-ray beam can be “pre-hardened” with substantial filtering at the X-ray source; this can result in reduced beam-hardening artifacts when scanning the same object on a linac-based system versus a system based on a Coolidge-type X-ray tube.

As may be appreciated, and considering the above factors, comparing the image quality (IQ) of images from different scanners can be challenging. In particular, IQ characteristics may be subject to tradeoffs such that one characteristic improves at the expense of another and it can be unclear which tradeoff leads to the “best” IQ. Therefore, it is important to consider IQ in the context of the purpose of the scan, or the “measurement task”. Conversely, when developing or optimizing a scanner, it is also important to understand the underlying factors that contribute to success or failure of the imaging system's ability to perform the measurement task.

The present approaches relate to phantoms that may be used to address certain of these issues and facilitate comparison of IQ between CT imaging systems which, as described above, may vary widely in their imaging capabilities and underlying physics. As discussed herein, such phantoms may have a modular design, allowing various inserts of different sizes and/or shapes to potentially be accommodated as well as inserts with inclusions or other features that may allow certain features or defects of interest to be replicated. In this manner the modular phantom may be assembled or configured so as to correspond to (either specifically or broadly) a part or manufactured item that is to be scanned by the CT system being evaluated. It may also be noted that modular phantoms and/or inserts as discussed herein may be fabricated using any suitable technique, including, but not limited to, additive and reductive manufacturing techniques. Thus, though an example mentioned herein may reference being manufactured in accordance with a particular technique (e.g., additive manufacturing), it should be understood that any suitable manufacturing technique may be employed unless explicitly stated otherwise.

As part of evaluating the use of modular phantoms as discussed herein, a variety of industrial CT scanner configurations were employed. As noted above, such scanners vary widely in configuration and performance, hence the problems noted herein with respect to comparing different systems in terms of image quality. With this in mind, to the extent that scanning results on modular phantoms described herein are discussed below, such results were generated using a variety of scanners, the configurations of which were as follows:

(A) High-energy fan-beam CT—Fan-beam scans were performed using an ICT (industrial CT) scanner having a linac X-ray source operating at 9 MeV with a 2-mm focal spot; a linear detector array (LDA) with approximately 1-mm-wide and 1-mm-tall pixels (dimensions projected to the system's axis of rotation) and 3-cm-deep scintillator. With respect to this configuration, due to the high X-ray energy and the deep scintillator, material penetration and X-ray detection is excellent with this configuration. Due to the pre-hardened X-ray spectrum, beam-hardening artifacts are minimal. Due to the fan-beam geometry, scatter artifacts are minimal. However, the system spatial resolution, on the order of 1 mm, is sub-optimal. In general, such a system can provide good image quality but at the cost of long scan times.
(B) High-energy cone-beam CT (first configuration)—The ICT scanner of configuration (A) was also configured with a (41 cm)² flat-panel detector (FPD) in place of the LDA for cone-beam scanning. The FPD was operated in low-resolution mode to achieve (336-μm)³ voxels (projected to the system's axis of rotation). This configuration provides faster scans that with configuration (A), but experienced lower image quality due to increased scatter.

(C) High-energy cone-beam CT (second configuration)—Cone-beam CT scans were also performed using a CT scanner having a linac X-ray source operating at 9 MeV with a 1.3-mm focal spot; a (41 cm)² FPD with approximately (163-μm)³ voxels (projected to the system's axis of rotation) and a Gd₂O₂S:Tb (GOS) scintillator. With respect to the scintillator, the one employed included a 208-μm-thick (100 mg/cm²) phosphor layer of polycrystalline particles in binder. The X-ray beam was substantially pre-hardened using 0.5 inches of tungsten. Due to the high X-ray energy, material penetration is excellent with this configuration. Due to the pre-hardened X-ray spectrum, beam-hardening artifacts are minimal but, due to the cone-beam geometry, scatter artifacts present a challenge with this configuration. The system spatial resolution, on the order of 250 microns at 9 MeV, is better than that of configuration (B) due to the smaller detector pixels and focal spot size but is still limited by the focal spot size. In general, such a system can provide good image quality and scan times are relatively short.

(D) Intermediate-energy cone-beam CT—Cone-beam CT scans were also performed using a CT scanner having commercially-available components including a fixed-anode X-ray tube operating at 450 kVp with a 0.4-mm×1-mm focal spot; a (41 cm)² FPD with approximately (163-μm)³ voxels (projected to the system's axis of rotation) and 500-micron-deep scintillator. Due to the intermediate X-ray energy, material penetration is moderate with this configuration. Due to the relatively broad X-ray spectrum, beam-hardening artifacts are challenging. Due to the cone-beam geometry, scatter artifacts are challenging. The system spatial resolution of this configuration, on the order of 150 microns, is better than that of configuration (C) due to the smaller focal spot size. In general, such a system can provide good image quality in relatively small-diameter parts and scan times are relatively short.
(E) Reduced-energy cone-beam micro-CT—Cone-beam micro-CT scans were also performed using a micro CT scanner having an X-ray tube and an FPD. The operating voltage and system geometry may be varied, with testing being done in discussed examples at 250 kV with a 50-μm focal spot, a (41 cm)² FPD with approximately (10-μm)³ voxels (projected to the system's axis of rotation), and 500-micron-deep scintillator. Due to the moderate X-ray energy, material penetration is poor with this configuration. Due to the small focal spot, which limits X-ray tube current, and the high system magnification, only small (<1″ diameter) objects can be scanned in reasonable times. However, due to the small focal spot, high system magnification, and relatively thin scintillator, the system spatial resolution, on the order of 10 μm, exceeded that of any of the other CT scanning configurations described above. In general, such a system can provide excellent spatial resolution for small objects.

With the preceding context in mind, and as discussed in greater detail herein, a modular phantom as presently contemplated may be useful in allowing image quality comparisons to be made across a range of CT systems such as those noted above. As used herein, a modular phantom may comprise a phantom body and one or more removable inserts that may be removed, inserted, or replaced within the phantom body, such as to modify the modular phantom to correspond to a real-world part or object (e.g., a manufactured part) for which imaging data might be acquired. In certain embodiments, the inserts are of such a size as to allow imaging with micro-CT. Further, the phantom bodies, as discussed in greater detail below, may have one or more of the following properties: (1) uniform geometry in the longitudinal direction (i.e., in the z-direction or imaging bore direction of a CT scanner), (2) symmetric (e.g., circular or polygonal) cross-sections, (3) representative of or correspondence to specific part types (e.g., an airfoil, etc.), or (4) variable scatter levels. In practice, it may be useful for the materials used to fabricate such modular phantoms to correspond to materials present in real-world objects that undergo NDT and/or that are readily available and easy to machine or otherwise fabricate. Further it may be desirable for the phantom designs to be capable of being fabricated in a conventional machine shop or other widely-available production method such as, for example, additive manufacturing, casting, etc. Lastly, with respect to the inserts, such inserts may be selected or employed so as to facilitate measurement of common metrics (e.g., modulation transfer function (MTF), contrast-to-noise ratio (CNR)) and/or to facilitate measurement of features (e.g., wall thickness, cracks, pores, etc.).

With respect to materials used to fabricate a modular phantom (e.g., the phantom body and/or insert) as discussed herein, such materials may include, but are not limited to, aluminum as well as high-density alloys, such as carbon steel, chrome steel, stainless steel, Inconel, cobalt-chromium-molybdenum, Hastelloy C22, tungsten carbide, and so forth. In general, such alloys may employ combinations of two or more of aluminum, copper, manganese, silicon, magnesium, zinc, iron, carbon, chromium, nickel, niobium, molybdenum, cobalt, titanium, tantalum, tungsten, vanadium, or other suitable elements. The CT attenuation and resulting CT image characteristics are dominated by the X-ray attenuation characteristics of the dominant elements in the alloy. For the purpose of the present examples discussed below, stainless steel (in particular, SS-304) was selected as the phantom material due to its ready availability, resistance to oxidation, and ease to machine. However, a modular phantom as discussed herein may be fabricated using any suitable material, such as a high-density alloy as described above and need not be limited to metal or metallic alloys. For example, the phantom body and/or insert may instead be made from one or more of ceramics, plastics, composites, and so forth.

In practice, a modular phantom and/or inserts as described herein may be fabricated using suitable machining techniques. Such techniques include, but are not limited to: manual machines (e.g., drill presses and lathes) as well as more sophisticated machinery, such as numerical-controlled (NC) milling machines, water-jet machines, and electrical discharge (EDM) machines. Similarly, additive manufacturing techniques may also be employed to manufacture all or part of a respective phantom body or insert.

Turning to examples of implementations, as described herein a phantom body may be fabricated that is capable of receiving one or more removable inserts. With respect to the inserts, for inserts that include very small features, it is useful to have a means to determine the “ground truth” size of those features. Micro-CT scanning (see e.g., CT scanner configuration E) can achieve the resolution necessary to precisely estimate, for example, the volume of a 5- to 10-mil diameter sphere, such as a pore within or at the surface of an insert. However, to achieve this resolution, the diameter of the insert must be smaller than the field of view (FOV) of the scanner when in high-resolution mode. A ½-inch diameter insert satisfies this requirement, and ½-inch-diameter rod stock is readily available for use in fabricating such a ½-inch diameter insert, though other sizes and shapes may also be suitable for inserts and insert fabrication.

With the preceding in mind, examples of phantom bodies constructed for testing of the present techniques were designed to accommodate a nominal ½-inch diameter insert, with holes for inserts specified at 5.001+0.001−0 inches. This design also provided a mechanism for precisely aligning each insert rotationally and 8 orientations (at 45° increments) were provided for flexibility. As will be appreciated, other dimensions, orientations, and angular increments may also be suitable for use with modular phantoms as presently contemplated and such ranges and increments are merely provided by way of example.

In a further aspect, modular phantoms constructed in accordance with the present approach may have a uniform geometry in the longitudinal (i.e., z) dimension. In particular, it may be noted that, when scanning a true object or part undergoing NDT and having non-uniform longitudinal cross sections, every image plane (slice) can be unique. This makes it difficult to reproducibly assess images from such “real” parts or objects because it can be difficult to identify the same plane each time. Furthermore, getting statistical results is difficult because to produce multiple instances of the same cross section, multiple scans are required.

With this in mind, a longitudinally-uniform phantom provides the ability to obtain multiple instances of the phantom cross section is one scan. This enables: (a) estimation of spatially-variant random noise (therefore an average random noise and a random noise uniformity score can be calculated), (b) removal of the random noise by averaging, thus leaving only artifacts (therefore an artifact score can be assigned by, for example, calculating the spatial standard deviation in an ROI), (c) assessment of wall thickness measurement accuracy and precision with one scan, and (d) improvement of the fidelity of spatial resolution measurements (e.g. MTF) by including multiple instances of the object's cross section, thereby averaging the random noise.

The thickness of the phantom may, in some implementations, be thick enough to image a statistically meaningful number (e.g. 50-100) of image slices but thin enough to produce relatively low scatter. That is, sizing of the phantom in such an implementation may involve a tradeoff between the number of slices acquirable and the scatter introduced; this tradeoff may be resolved based on the NDT application being evaluated. By way of example, a ½-inch thick phantom would produce far less scatter than a 2-inch thick phantom but, considering all the other design requirements, might not produce enough identical slices for good statistics. In a phantom implementation evaluated for study purposes, phantom bodies were designed to be 1-inch thick and have longitudinally-uniform cross sections.

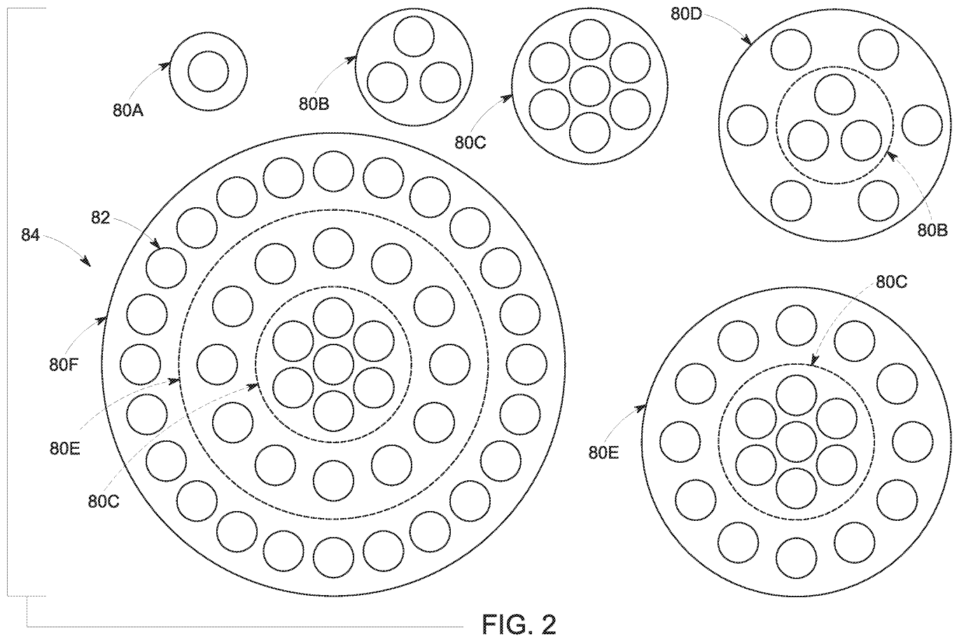

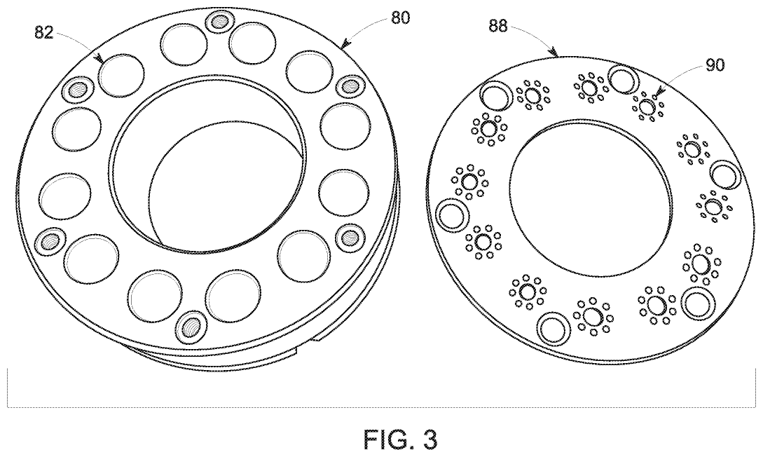

In an additional aspect, in some implementations it may be useful for a phantom body to have a symmetric (e.g., circular or polygonal) cross-section. With this in mind, nested phantoms of an annular shape were conceptualized, as shown in FIG. 2. In particular, FIG. 2 depicts views of certain modular phantom bodies 80 as seen from an end-view or cross-section. As seen, each body 80 contains at least one cavity 82 sized to receive a removable insert. In addition, as may be seen in this example, in some implementations the phantom bodies 80 may themselves be nested one in another so as to allow a user to create an overall phantom, e.g. 84, having the desired dimensions or shape. In principle, such a set of nestable phantom bodies 80 could cover a wide range of scanning requirements. An intermediate size in this nested concept was designed and fabricated. This fabricated example (with a cross section represented by 80E) had a 4-inch outside diameter (OD), 2-inch inside diameter (ID) and included 12½-inch diameter holes for inserts, spaced uniformly around the annulus at 30° increments. An image of this example phantom body 80 with a mountable cover 88 is shown in FIG. 3. The cover 88 includes holes 90 for precisely aligning insert orientations in 45° increments.

In yet another aspect, a modular phantom may instead be formed so as to generally correspond to a specific manufactured part or object that might undergo NDT. As noted herein, it may be particularly desirable for a phantom 84 as discussed herein to correspond to a manufactured part or good that is to be imaged for NDT. Where such a part is known or were otherwise justified, it may therefore be useful to form the phantom body 80 so as to specifically or generally correspond to the known manufactured good.

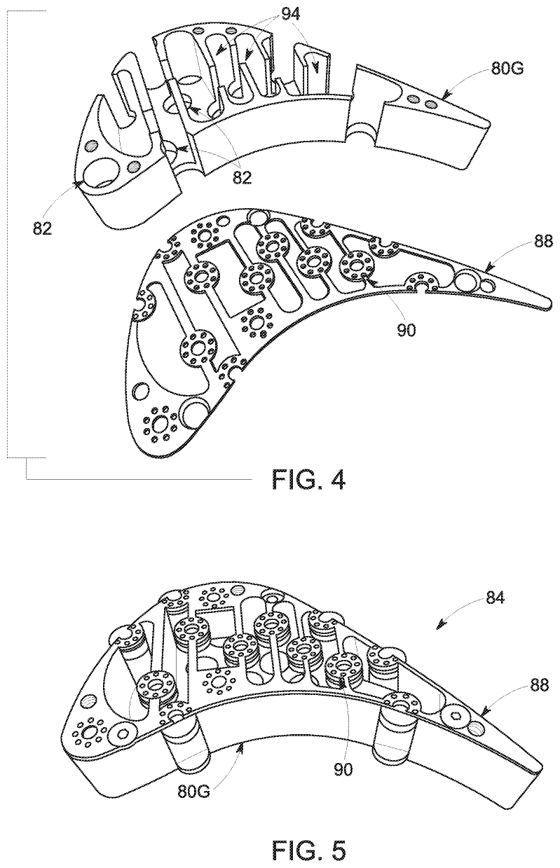

Such as example is shown in FIG. 4 (showing a separated phantom body 80 and cover 88) and FIG. 5 (showing the assembled phantom body 80G and cover 88. In this example, the phantom body 80F and cover 88 are formed in the shape of a generic airfoil design. The fabricated phantom body example has dimensions of approximately 2.5 inches×6 inches in cross-section and 1 inch in thickness. The phantom body 80G includes 6 internal gussets 94. The external walls and the internal gussets have ½-inch diameter holes 82 for inserts in 12 locations and, for flexibility, there are 3 additional locations for other inserts. The cover 88 includes holes 90 for precisely aligning insert orientations in 45° increments.

In a further aspect, modular phantoms constructed in accordance with the present approach may have a variable geometry in the longitudinal (i.e., z) dimension. In particular, it may be noted that, when scanning a true object or part undergoing NDT and having non-uniform longitudinal cross sections, every image plane (slice) can be unique, which makes IQ evaluation more challenging. However, the effect of variable geometry in the longitudinal direction on IQ might be the effect that is desired to evaluate. In this case, a more complex phantom body with variable geometry can be fabricated, including holes to accept inserts with the inserts' longitudinal axis oriented either parallel or non-parallel to the phantom body's longitudinal axis. In this implementation, more sophisticated analysis methods might be required compared to the case of the longitudinally-uniform phantom body. However, this implementation affords evaluation of specific IQ challenges that might arise from the variable geometry in the longitudinal direction.

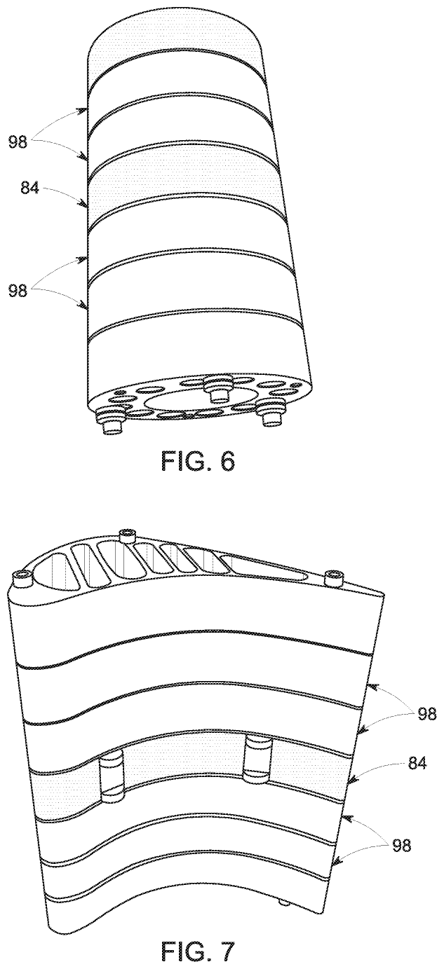

In a further aspect, in some implementations it may be useful to be able to vary the level of scatter generated by the modular phantom 84. In one implementation, this may be accomplished by stacking the imaged phantom 84 with one or more scatter-producing extensions 98, as shown in FIG. 6 (with respect to the annular phantom of FIG. 4) and FIG. 7 (with respect to the airfoil phantom of FIGS. 4 and 5). In one implementation, the scatter-producing extensions 98 are of a suitable thickness (e.g., 0.5 inches, 1 inch, 1.5 inches, 2 inches, and so forth) and otherwise generally correspond to the cross-section of the phantom 84. Alternatively, some or all of the scatter-producing extensions 98 may have a different cross-section than the imaged phantom 84, thereby emulating a real part that is longitudinally non-uniform. By controlling the number of scatter-producing extensions 98 stacked with the imaged phantom 84, a user may vary the level of scatter generated when the phantom 84 is images, with more scatter-producing extensions 98 corresponding to more scatter. In one implementation, the scatter-producing extensions 98 are designed to mimic the phantom bodies 84 that they mate with but with less demanding tolerances.

While the preceding relates various implementations of a modular phantom body 80 capable of receiving removable inserts, a discussion of implementations of the inserts is now provided. In particular, inserts suitable for measurement of common metrics, such as modulation transfer function (MTF), contrast-to-noise ratio (CNR), and so forth and for measurement of features, such as wall thickness, cracks, pores, and so forth, are envisioned.

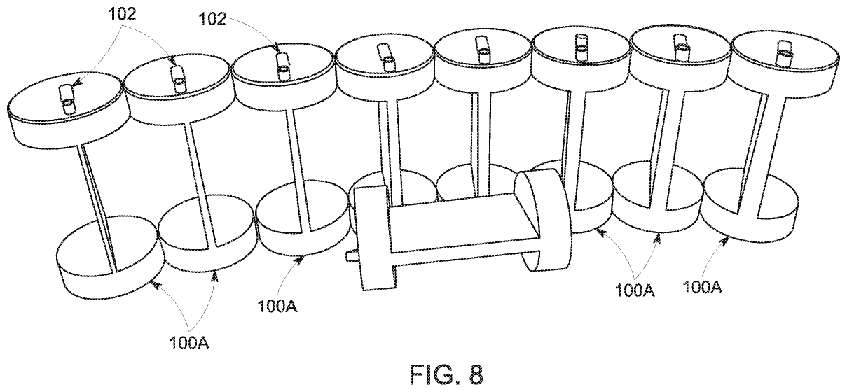

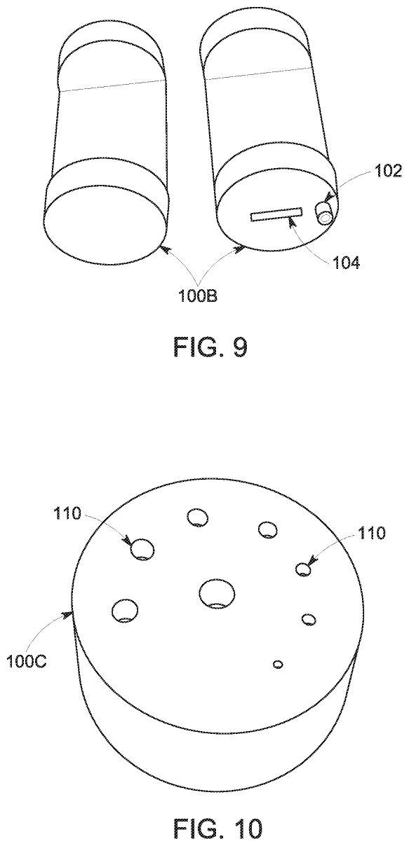

To evaluate the present approach, inserts 100 were fabricated from readily-available ½-inch diameter SS-304 rod cut to 1″ length, and small dowel pins 102 were installed on one end for insertion alignment. These were then machined using NC EDM into ½-inch-tall rods and 1-inch-tall rods with several different cross sections including semi-circle inserts 100B (FIG. 9) and symmetrical gussets 100A (FIG. 8) with walls ranging from 15 mils to 200 mils thick. Alternatively, the inserts 100 could instead be formed as a solid cylinder with height of the full or partial height of the phantom body (e.g., full, medium, and short height cylindrical inserts. The semicircle inserts 100B can be used to measure IQ metrics. The respective gusset inserts 100A from this fabrication study are uniform in the z-dimension, as discussed above, and can be used to assess wall thickness measurement capability. In one embodiment, each insert 100 has a pin 102 and slot 104 on one end. The pin 102 mates with holes in the phantom cover 88 and the slot 104 facilitates insert rotation for pin-to-hole alignment during phantom/insert assembly.

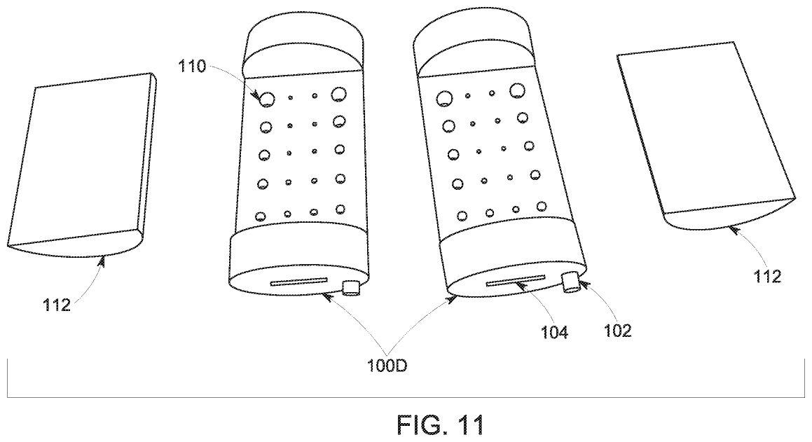

In a further insert implementation small pores 110 were introduced on the ends of some ½-inch-tall rods (inserts 100C, FIG. 10) and on the flat faces of some 1-inch-tall semi-circle inserts (inserts 100D, FIG. 11) with semi-circle cross sections. Pore 110 sizes ranged from approximately 10 mils to 55 mils and target depths were approximately equal to the diameters (1× pores) and twice the diameters (2× pores). The inserts 100C and 100D having pores 110 can be scanned so as to emulate “surface-breaking” or “open” pores. Alternatively, the surface with the pores 110 can be closed off with a cover 112 to emulate “embedded” or “closed” pores. Likewise, the pores in inserts 100C can be closed off using a partial-height rod as a cover. These closed pores can represent, for example, inclusions in a cast-metal part or, in an additively-manufactured part, pores that can contain residual metal powder that was not cleared during the manufacturing process. The advantage to emulating the latter pores using a modular insert with cover is that the size and geometry of the pore can be assessed using micro-CT and a pore with residual powder can be emulated by partially or completely filling the pore with metal powder and applying the cover; the resulting assembly can again be assessed with micro-CT for comparison with results obtained with macro-CT.

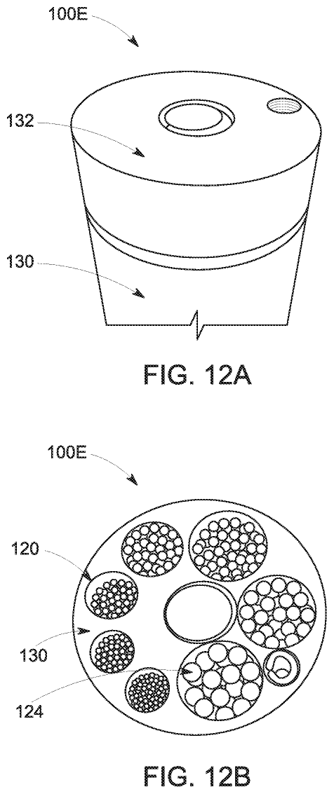

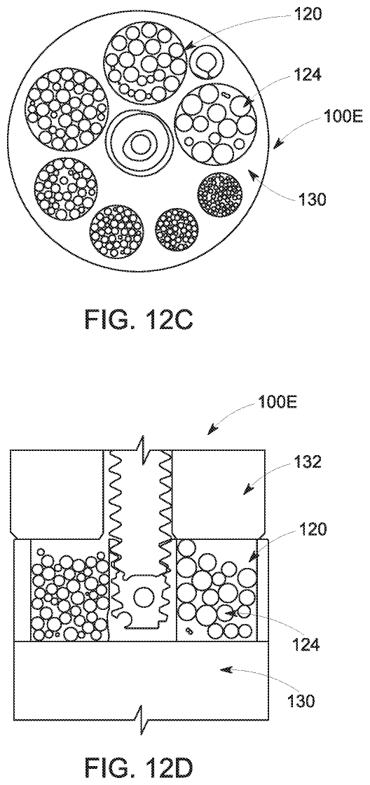

In an additional insert embodiment, shown collectively at various angles and views in FIGS. 12A, 12B, 12C, and 12D, an insert 100E is provided having openings 120 holding differently sized “balls” 124 or other structures. In a fabrication example, such an insert 100E was fabricated with dimensions of ½-inch diameter×1-inch long and is made of SS-304. This example is comprised of an insert body 130 with a cover 132 and, in the body 130, there are cylindrical “buckets” 120 filled with chrome-steel ball bearings 124; the ball bearings 124 range in size from 10 mils to 40 mils. In such an implementation, the “buckets of balls” represent well-defined structures that to some extent are equivalent to porous metal. Because the sizes of the balls 124 are very precisely known, an algorithm could be developed that would enable IQ assessment related to porosity. The 3D structure formed by precision manufactured balls can also serve as a resolution gauge for visual or quantitative image quality evaluation. Such 3D resolution gauge can be otherwise impractical to machine or manufacture. If the sizes of the balls are not precisely known, relative comparison between different CT systems may still be made based on the visibility or detectability of individual balls or other derived parameters such as the volume fraction of the balls in the reconstructed image. Micro-CT may also be used to establish ground truth images. In another implementation, the balls can made of metal, plastic, foam or other materials. Higher density balls can be mixed with lower density ones with different ratios for various detection tasks. A mixture of balls with variations in density, material, or size may be used for more complicated detection and material discrimination tasks. The balls can also be suspended in a containing media such as epoxy.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A modular, configurable phantom for use in X-ray imaging, comprising:
one or more removable inserts of variable design; and
one or more phantom bodies, wherein each phantom body comprises at least one space configured to receive the respective removable inserts.

2. The modular phantom of claim 1, wherein the one or more inserts have features that can be accurately and/or precisely measured when in insert form but that could not be accurately and/or precisely measured if those features existed within the phantom body itself.

3. The modular phantom of claim 1, wherein the one or more inserts are sized so as to be capable of being imaged by micro-computed tomography (micro-CT).

4. The modular phantom of claim 1, wherein the one or more phantom bodies comprises at least two phantom bodies configured to be combined in a nested configuration.

5. The modular phantom of claim 1, further comprising a cover plate configured to attach to the one or more phantom bodies.

6. The modular phantom of claim 1, wherein the one or more phantom bodies are shaped to correspond to a part on which non-destructive testing (NDT) is performed.

7. The modular phantom of claim 1, further comprising one or more scatter-producing extensions configured to attach to the one or more phantom bodies to extend the modular phantom in at least a first dimension.

8. The modular phantom of claim 1, wherein the one or more removable inserts comprise a solid cylinder with height of the full or partial height of the phantom body, a gusset insert, a semi-circle insert, a pore insert, or a bucket-of-balls insert.

9. The modular phantom of claim 1, wherein the one or more phantom bodies have a variable geometry or cross-section in a longitudinal (z) direction.

10. The modular phantom of claim 9, wherein the variable geometry or cross-section in the longitudinal (z) direction represents a specific manufactured part or type of part.

11. The modular phantom of claim 1, wherein the one or more phantom bodies have a uniform geometry or cross-section in a longitudinal (z) direction.

12. The modular phantom of claim 1, wherein the one or more phantom bodies are sufficiently thick so as to allow imaging of 50 to 100 slices in one exposure event.

13. The modular phantom of claim 1, wherein the one or more phantom bodies have symmetric cross-sections.

14. The modular phantoms of claim 13, wherein the symmetric cross-sections are polygonal or circular.

15. The modular phantom of claim 1, wherein the one or more inserts provide for measurement of metrics.

16. The modular phantom of claim 15, wherein the metrics comprise one or more of modulation transfer function or contrast-to-noise ratio.

17. The modular phantom of claim 1, wherein the one or more inserts provide for measurement of features.

18. The modular phantom of claim 17, wherein the features comprise one or more of wall thickness, cracks, or pores.

19. The modular phantom of claim 1, wherein the one or more removable inserts further comprise a pin feature configured to mate with a complementary hole of a respective phantom body or of a cover.

20. The modular phantom of claim 1, wherein the one or more removable inserts further comprise a slot to facilitate rotation of a respective removable insert when inserted into a respective phantom body.

21. A removable insert, comprising:
an insert body configured to fit within an opening of a phantom body; and
one or more structures that facilitate measurement of one or both of metrics or features when imaged.

22. The removable insert of claim 21, wherein the insert body comprises a cylindrical body.

23. The removable insert of claim 21, wherein the metrics comprise one or more of modulation transfer function or contrast-to-noise ratio.

24. The removable insert of claim 21, wherein the features comprise one or more of wall thickness, cracks, or pores.

25. The removable insert of claim 21, wherein the one or more structures comprise one or more of a solid cylinder with height of the full or partial height of the phantom body, a gusset, a semi-circle cross-section, a plurality of pores, or one or more buckets of balls.

26. A method for assessing image quality of a computed tomography (CT) system, comprising:
positioning a modular phantom within an industrial CT system, wherein the modular phantom comprises:
one or more removable inserts, wherein the one or more removable inserts comprise a solid cylinder with height of the full or partial height of the phantom body, a gusset insert, a semi-circle insert, a pore insert, or a bucket of balls insert; and
one or more phantom bodies, wherein each phantom body comprises at least one space configured to receive the respective removable inserts and wherein the one or more phantom bodies have either variable or a uniform geometry or cross-section in a longitudinal (z) direction;
scanning the modular phantom to acquire one or more images suitable;
comparing one or more image quality characteristics of the one or more images with comparison images taken of the modular phantom using a different industrial CT system.
